(19) United States
(12) Patent Application Publication
(10) Pub. No.: US 2015/0329380 A1
(43) Pub. Date: Nov. 19, 2015

(54) CLEANING APPARATUS

(71) Applicant: TROJAN TECHNOLOGIES, London (CA)

(72) Inventors: Chongze Zhu, Shanghai (CN); Yonglin Chen, Shanghai (CN)

(21) Appl. No.: 14/650,426

(22) PCT Filed: Dec. 9, 2013
(86) PCT No.: PCT/CA2013/001011

§ 371 Date: Jun. 8, 2015

Related U.S. Application Data
(60) Provisional application No. 61/734,479, filed on Dec. 7, 2012.

(51) Int. Cl. C02F 1/32; B08B 1/00

(52) U.S. Cl. CPC C02F 1/325; B08B 1/008; C02F 2201/3223; C02F 2201/324

(57) ABSTRACT

There is disclosed a cleaning apparatus for a radiation source assembly in a fluid treatment system. The cleaning system comprises: a cleaning carriage comprising at least one cleaning element for contact with at least a portion of the exterior of the radiation source assembly; a rodless cylinder comprising an elongate housing having a longitudinal axis; a slidable element disposed on an exterior surface of the elongate housing, the slidable element being: (i) coupled to the cleaning carriage, and (ii) magnetically coupled to a driving element disposed within the elongate housing, the driving element comprising a friction modifying element in contact with an interior surface of the elongate housing to define a first frictional resistance in a rotational direction about the longitudinal axis and a second frictional resistance in an axial direction along the longitudinal axis, the friction modifying element configured such that the first frictional resistance is greater than the second friction resistance; and an elongate motive element coupled to the driving element.

### CROSS-REFERENCE TO RELATED APPLICATION

The present application claims the benefit under 35 U.S.C. §119(e) of provisional patent application Ser. No. 61/734,479, filed Dec. 7, 2012, the contents of which are hereby incorporated by reference.

### BACKGROUND OF THE INVENTION

1. Field of the Invention

In one of its aspects, the present invention relates to a cleaning apparatus. In yet another of its aspects, the present invention relates to a radiation source module containing the cleaning system. In another of its aspects, the present invention relates to a method of removing fouling materials from an exterior surface of a radiation source assembly. Other aspects of the invention will become apparent to those of skill in the art upon reviewing the present specification.

2. Description of the Prior Art

Fluid treatment systems are known generally in the art.

For example, U.S. Pat. Nos. 4,482,809, 4,872,980 and 5,006,244 [all in the name of Maarschalkerweerd and hereinafter referred to as the Maarschalkerweerd #1 patents] all describe gravity fed fluid treatment systems which employ ultraviolet (UV) radiation.

Such systems include an array of UV lamp frames which include several UV lamps each of which are mounted within sleeves which extend between and are supported by a pair of legs which are attached to a cross-piece. The so-supported sleeves (containing the UV lamps) are immersed into a fluid to be treated which is then irradiated as required. The amount of radiation to which the fluid is exposed is determined by the proximity of the fluid to the lamps, the output wattage of the lamps and the fluid's flow rate past the lamps. Typically, one or more UV sensors may be employed to monitor the UV output of the lamps and the fluid level is typically controlled, to some extent, downstream of the treatment device by means of level gates or the like.

Depending on the quality of the fluid which is being treated, the sleeves surrounding the UV lamps periodically become fouled with foreign materials, inhibiting their ability to transmit UV radiation to the fluid. For a given installation, the occurrence of such fouling may be determined from historical operating data or by measurements from the UV sensors. Once fouling has reached a certain point, the sleeves must be cleaned to remove the fouling materials and optimize system performance.

If the UV lamp modules are employed in an open, channel system (e.g., such as the one described and illustrated in Maarschalkerweerd #1 patents), one or more of the modules may be removed while the system continues to operate, and the removed frames may be immersed in a bath of suitable cleaning solution (e.g., a mild acid) which may be air-agitated to remove fouling materials. This practice was regarded by many in the field as inefficient, labourious and inconvenient.

In many cases, once installed, one of the largest maintenance costs associated with prior art fluid treatment systems is often the cost of cleaning the sleeves about the radiation sources.

U.S. Pat. Nos. 5,418,370, 5,539,210 and RE36,896 [all in the name of Maarschalkerweerd and hereinafter referred to as the Maarschalkerweerd #2 patents] all describe an improved cleaning system, particularly advantageous for use in gravity fed fluid treatment systems which employ UV radiation. Generally, the cleaning system comprises a cleaning carriage engaging a portion of the exterior of a radiation source assembly including a radiation source (e.g., a UV lamp). The cleaning carriage is movable between: (i) a retracted position wherein a first portion of radiation source assembly is exposed to a flow of fluid to be treated, and (ii) an extended position wherein the first portion of the radiation source assembly is completely or partially covered by the cleaning carriage. The cleaning carriage includes a chamber in contact with the first portion of the radiation source assembly. The chamber is supplied with a cleaning solution suitable for removing undesired materials from the first portion of the radiation source assembly.

The cleaning system described in the Maarschalkerweerd #2 patents represented a significant advance in the art, especially when implemented in the radiation source module and fluid treatment system illustrated in these patents. However, implementation of the illustrated cleaning system in a fluid treatment module such as the one illustrated in the Maarschalkerweerd #1 patents is problematic.

This problem was addressed by U.S. Pat. No. 6,342,188 [Pearcey et al. (Pearcey)]. Pearcey teaches the use of rodless cylinder as the driving mechanism for a cleaning system (e.g., the one taught by the Maarshalkerweerd #2 patents or other cleaning systems). In the illustrated embodiments, Pearcey teaches the use of a hydraulic/pneumatic system (e.g, FIG. 6 of Pearcey) or a screw drive (FIG. 9 of Pearcey) to move a piston contained within the rodless cylinder. The piston is magnetically coupled to a slidable member on the exterior of the rodless cylinder. The slidable member is coupled to a cleaning carriage containing one or more cleaning rings. Thus, once the piston is moved within the rodless cylinder, the slidable member/cleaning carriage are correspondingly moved.

The hydraulic/pneumatic systems taught by Pearcey can be problematic. In the implementation of these systems a hydraulic pump or air compressor used centrally in the fluid treatment system was also used to drive the rodless cylinder. The pressurized feed was transferred to the rodless cylinder through the use of manifolds and tubing to the manifolds. Unfortunately, the tubing, the manifolds and their associated fittings tend to develop leaks over time causing a drop in pressure and, in the case of the hydraulic pump, an environmental concern from spilled hydraulic fluid. The pneumatic approach (use air compressors) is problematic since it does not provide a constant force to the rodless cylinder. Specifically, since air is compressible, pressure can build up if the system jams resulting in violent stops and starts of the cylinder during operation. Also, such hydraulic/pneumatic systems are relatively expensive to fabricate and service.

For these reasons, the screw drive system taught by Pearcey was investigated. The use of such a system generally overcame the above problems associated with the hydraulic/pneumatic systems. However, a different problem was raised. Specifically, in the implementation of the screw drive system taught by Pearcey, a coupling nut was used to engage the screw drive. When the coupling nut was used and the screw drive was actuated, the coupling nut would turn with the screw of the screw drive. If a key was used to secure the coupling nut, the key would need to be as long as the rodless cylinder—this was not a practical solution given the practical space constraints posed in the interior of the rodless cylinder. Pearcey also taught an enclosed screw drive such that it would not be exposed to debris, meaning that it would not be subject to binding and subsequent damage.

Accordingly, it would be desirable to have a solution to the problem associated with implementing the a non-hydraulic/pneumatic drive member such as the screw drive system taught by Pearcey.

### SUMMARY OF THE INVENTION

It is an object of the present invention to obviate or mitigate at least one of the above-mentioned disadvantages of the prior art.

It is another object of the present invention to provide a novel cleaning apparatus.

Accordingly, in one of its aspects, the present invention provides a cleaning apparatus for a radiation source assembly in a fluid treatment system, the cleaning system comprising:

a cleaning carriage comprising at least one cleaning element for contact with at least a portion of the exterior of the radiation source assembly;

a rodless cylinder comprising an elongate housing having a longitudinal axis;

a slidable element disposed on an exterior surface of the elongate housing, the slidable element being: (i) coupled to the cleaning carriage, and (ii) magnetically coupled to a driving element disposed within the elongate housing, the driving element comprising a friction modifying element in contact with an interior surface of the elongate housing to define a first frictional resistance in a rotational direction about the longitudinal axis and a second frictional resistance in an axial direction along the longitudinal axis, the friction modifying element configured such that the first frictional resistance is greater than the second friction resistance; and

an elongate motive element coupled to the driving element.

In another of its aspects, the present invention provides a radiation source module comprising the cleaning apparatus.

In yet another of its aspects, the present invention provides a fluid treatment system comprising the radiation source module.

Thus, the present inventor has discovered a novel cleaning apparatus which overcomes the above-mentioned problem associated with implementation of a non-hydraulic/pneumatic drive member such as the screw drive member taught by Pearcey. This problem is solved by incorporation in the driving element of a so-called “friction modifying element” that is in contact with the interior surface of the elongate housing of the rodless cylinder.

In a preferred embodiment, the friction modifying element in the present cleaning apparatus may comprise a curved surface (the interior portion of elongate housing of the Rodless cylinder), a roller element and a ramp (preferably disposed on an annular element described in more detail below). The roller element is disposed between the ramp and the curved surface thereby creating friction as it is driven into a wedge-shaped aperture formed by the combination of the curved surface and the ramp. The creation of this friction substantially prevents rotation of the driving member about a longitudinally axis of the elongate housing of the rodless cylinder. Rather, movement of the driving member along the longitudinal axis of the elongate housing of the rodless cylinder becomes is facilitated.

In the preferred embodiment of the present cleaning apparatus, the materials used for the elongate housing of the rodless cylinder, the roller element and the annular element (comprising the ramp) may be selected from a variety of materials, provided the material is sufficiently durable. For example, these elements may be made from a metal, a ceramic, a plastic and the like. Different materials can be used for different elements.

When a roller element is used in the preferred embodiment of the present cleaning apparatus, it is a preferred that it has a length and diameter wherein the ratio of the length to the diameter is in the range from about 1.5 to about 6, more preferably from about 3 to 6, most preferably about 5. In this preferred embodiment, it is further preferred that the ratio of the diameter of the roller element to the inner diameter of the elongate housing of the rodless cylinder is in the range of from about 10 to about 15, more preferably from about 11 to about 13, most preferably about 12.

In the preferred embodiment, the friction modifying element comprises a roller element which is disposed in a receptacle contained in an annular element that is coupled to the driving member. In this preferred embodiment, the roller element is substantially cylindrical in shape (i.e., it has a substantially circular cross-section). Of course, other embodiments are possible. For example, the roller element can have a cone-shaped cross-section. Alternatively, the roller element could also be in the form a ball bearing. Further, the roller element could have an elliptical cross-section.

It is also possible in this preferred embodiment to pre-load the roller element with a biasing member, such as a spring, which urges the roller element into position (similar to a limited slip or locking differential). The use of such a biasing element may allow more control or tuning of the initial friction of the roller element and allow greater tolerance in machining element as variability will be compensated for by the spring. The use of such a biasing element can effectively preload the friction modifying element in a manner such that rotation is prevented even in a resting state (i.e., even when the driving element is not actuated) of the cleaning apparatus. The biasing element may be a coil spring, a leaf spring, an elastomer and the like.

### BRIEF DESCRIPTION OF THE DRAWINGS

Embodiments of the present invention will be described with reference to the accompanying drawings, wherein like reference numerals denote like parts, and in which:

FIG. 1 illustrates a perspective view of a preferred embodiment of the present cleaning apparatus (without the cleaning carriage and connected hardware for clarity);

FIG. 2 illustrates a top view of the embodiment illustrated in FIG. 1;

FIG. 3 illustrates a side elevation (without the motor cover) of the embodiment illustrated in FIG. 2;

FIG. 4 is a sectional view along line IV-IV in FIG. 3;

FIG. 5 illustrates a side elevation of a portion of the embodiment illustrated in FIG. 4;

FIG. 6 illustrates a sectional view taken along the line VI-VI in FIG. 5;

FIG. 7 illustrates enlarged portion A taken from FIG. 6;

FIG. 8 is an enlarged sectional view taken along line VIII-VIII in FIG. 4; and

FIGS. 9-11 illustrate various views of the preferred form of the annular element used in the embodiments illustrated in FIGS. 1-8.

### DETAILED DESCRIPTION OF THE PREFERRED EMBODIMENTS

The present invention relates to a cleaning apparatus for a radiation source assembly in a fluid treatment system, the cleaning system comprising: a cleaning carriage comprising at least one cleaning element for contact with at least a portion of the exterior of the radiation source assembly; a rodless cylinder comprising an elongate housing having a longitudinal axis; a slidable element disposed on an exterior surface of the elongate housing, the slidable element being: (i) coupled to the cleaning carriage, and (ii) magnetically coupled to a driving element disposed within the elongate housing, the driving element comprising a friction modifying element in contact with an interior surface of the elongate housing to define a first frictional resistance in a rotational direction about the longitudinal axis and a second frictional resistance in an axial direction along the longitudinal axis, the friction modifying element configured such that the first frictional resistance is greater than the second friction resistance; and an elongate motive element coupled to the driving element. Preferred embodiments of this cleaning apparatus may include any one or a combination of any two or more of any of the following features:
the friction modifying element is configured to substantially prevent rotation of the driving element about the longitudinal axis;
the driving element is coaxially oriented with respect to the longitudinal axis of the elongate housing;
the friction modifying element comprises an annular element having a receptacle portion configured to receive a roller element, the roller element configured to be in contact with the interior surface of the elongate housing;
the receptacle portion has cross-sectional shape configured to urge the roller element against the interior of the elongate housing open rotation of the annular element about the longitudinal axis;
the annular element comprises a first receptacle configured to receive a first roller element and a second receptacle configured to receive second roller element;
the first receptacle portion has first cross-sectional shape configured to urge the roller element against the interior of the elongate housing open rotation of the annular element about the longitudinal axis in a first direction;
the second receptacle portion has second cross-sectional shape configured to urge the roller element against the interior of the elongate housing open rotation of the annular element about the longitudinal axis in a second direction opposed to the first direction;
the first cross-sectional shape and the second cross-sectional shape are different;
the first cross-sectional shape and the second cross-sectional shape are substantially the same;
the first cross-sectional shape and the second cross-sectional shape are substantially mirror images of one another about an axis perpendicular to the longitudinal axis of the elongate housing;
the annular member comprises two or more pairs of the first receptacle and the second receptacle;
the annular member comprises three pairs of the first receptacle and the second receptacle;
the cleaning apparatus further comprises a key element configured to secure the friction modifying element with respect to the driving element.
the cleaning apparatus further comprises a key element configured to secure the annular element with respect to the driving element;
the friction modifying element is coupled to an end portion of the driving element;
the driving element comprises a pair of friction modifying elements;
the cleaning apparatus defined in claim 17, wherein the pair of friction modifying elements are coupled to opposed end portions of the driving element;
the motive element comprises an elongate mechanical drive disposed within the rodless cylinder;
the mechanical drive comprises an elongate rotatable member engaged with the driving element;
the driving element comprises a coupling element coupled to the mechanical drive;
the coupling element comprises an elongate passageway through which the elongate mechanical drive passes;
the elongate passageway has a longitudinal axis that is substantially coaxial with the longitudinal axis of the elongate housing;
the mechanical drive comprises an elongate rotatable screw element in engagement with the driving element;
the driving element is axially slidable within the elongate housing;
the driving element comprises a plurality of driving magnets and the slidable member comprises a plurality of driven magnets;
the rodless cylinder is submersible in a fluid to be treated;
the cleaning carriage comprises a plurality of cleaning rings;
the cleaning rings are annular;
the plurality of cleaning rings are arranged in parallel with respect to one another;
the cleaning carriage comprises at least one pair of cleaning rings opposed with respect to the rodless cylinder;
the cleaning carriage comprises a first plurality of cleaning rings and a second plurality of cleaning rings which are opposed with respect to the rodless cylinder;
the first plurality of cleaning rings and the second plurality of cleaning rings contain the same number of cleaning rings;
the cleaning carriage comprises a plurality of cleaning rings disposed in a substantially annular relationship with respect to the rodless cylinder;
each cleaning ring comprises a scraper element for scraping at least a portion of undesired materials from the exterior of the radiation source assembly when the slidable member is translated along the rodless cylinder;
each cleaning ring comprises a wiper element for wiping at least a portion of undesired materials from the exterior of the radiation source assembly when the slidable member is translated along the rodless cylinder;
each cleaning ring comprises a seal for sealing engagement with the portion of the exterior of the radiation source assembly, the seal removing at least a portion of undesired materials from the exterior of the radiation source assembly when the slidable member is translated along the rodless cylinder;
the cleaning ring comprises a chamber for surrounding a portion of the exterior of the radiation source assembly; and/or
the cleaning ring further comprises an inlet for introduction of a cleaning solution to the chamber.

The present invention further relates to a radiation source module comprising a radiation source module for use in a fluid treatment system, the module comprising: a frame having a first support member; at least one radiation source assembly extending from the first support member, the at least one radiation source assembly comprising a radiation source; and the above described cleaning apparatus. Preferred embodiments of this radiation source module may include any one or a combination of any two or more of any of the following features:
the radiation source module comprises means to position the radiation source module in the fluid treatment system;
the at least one radiation source assembly is in sealing engagement with the first support member;
the frame further comprises a second support member opposed to and laterally spaced from the first support member, the at least one radiation source assembly disposed between each of the first support member and the second support member;
the frame further comprises a third support member interconnecting the first support member and the second support member;
the frame further comprises a power supply for controlling the radiation source;
the first support member comprises a hollow passageway for receiving a lead wire for conveying electricity to the radiation source;
the radiation source assembly comprises a protective sleeve surrounding the radiation source;
the protective sleeve comprises a quartz sleeve;
the protective sleeve has an open end in sealed engagement with an opening in the first support member and a closed end supported by the second support member; and/or
the open end is sealed to prevent fluid ingress into the module.

The present invention further relates to a fluid treatment system comprising a fluid treatment zone for receiving a flow of fluid and at least one radiation source module as described above, wherein the at least one radiation source module is configured such that the one radiation source assembly is disposed in the fluid treatment zone. Preferred embodiments of this fluid treatment system may include any one or a combination of any two or more of any of the following features:
the fluid treatment zone is comprised in an open channel for receiving the flow of fluid;
the fluid treatment zone is comprised in a closed channel for receiving the flow of fluid;
the at least one radiation source assembly is elongate and has a longitudinal axis disposed transverse to the direction of fluid flow through the fluid treatment zone;
the at least one radiation source assembly is elongate and has a longitudinal axis disposed substantially parallel to the direction of fluid flow through the fluid treatment zone;
the at least one radiation source assembly is elongate and has a longitudinal axis disposed orthogonal to the direction of fluid flow through the fluid treatment zone; and/or
the at least one radiation source assembly is elongate and is disposed substantially vertically in the fluid treatment zone.

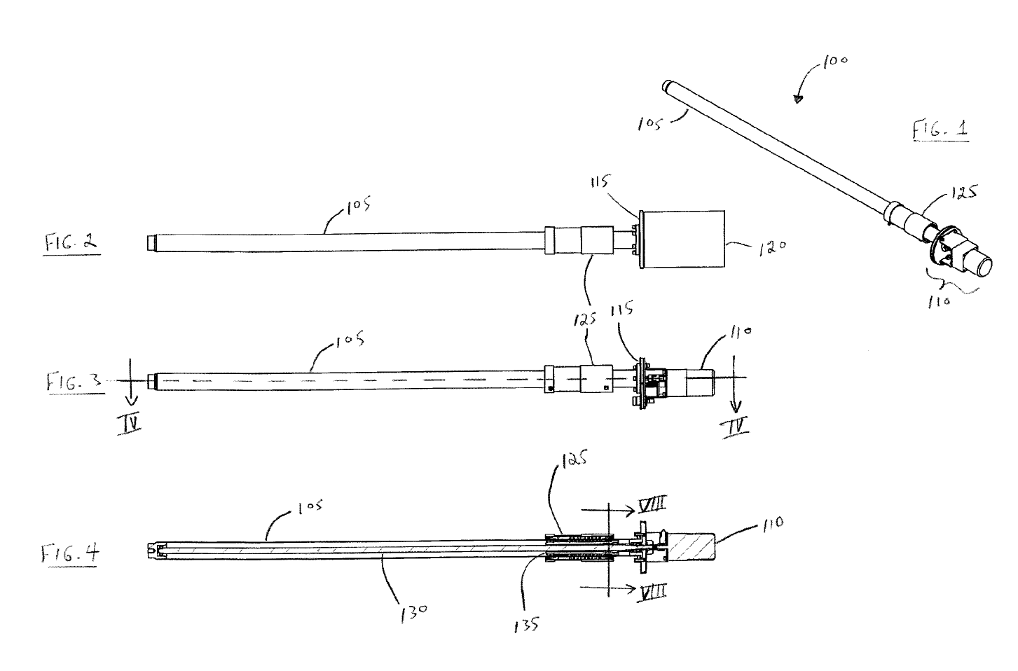

With reference to FIGS. 1-4, there is illustrated a cleaning apparatus 100.

As will be apparent to those of skill in the art, cleaning apparatus 100 does not include the cleaning carriage, cleaning chambers and other hardware, in a preferred embodiment, the radiation source module in which it is used. These details are convention can be found in Pearcey described above and in U.S. Pat. No. 6,646,269 [Traubenberg et al.]

Thus, cleaning apparatus 100 comprises a rodless cylinder 105 having one end coupled to a motor 110 via a coupling plate 115. Motor 110 can include a covering or shroud 120. Disposed on the exterior of rodless cylinder 105 is a slidable element 125. Disposed within rodless cylinder 105 is a screw drive element 130. Also disposed within rodless cylinder 105 is a driving element 135.

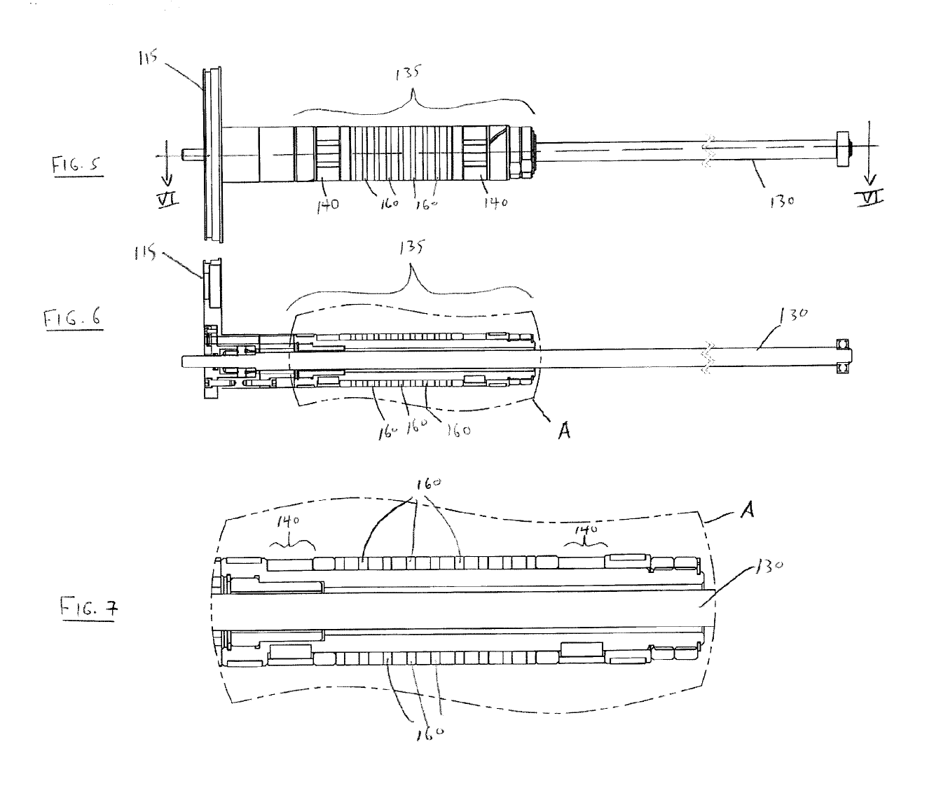

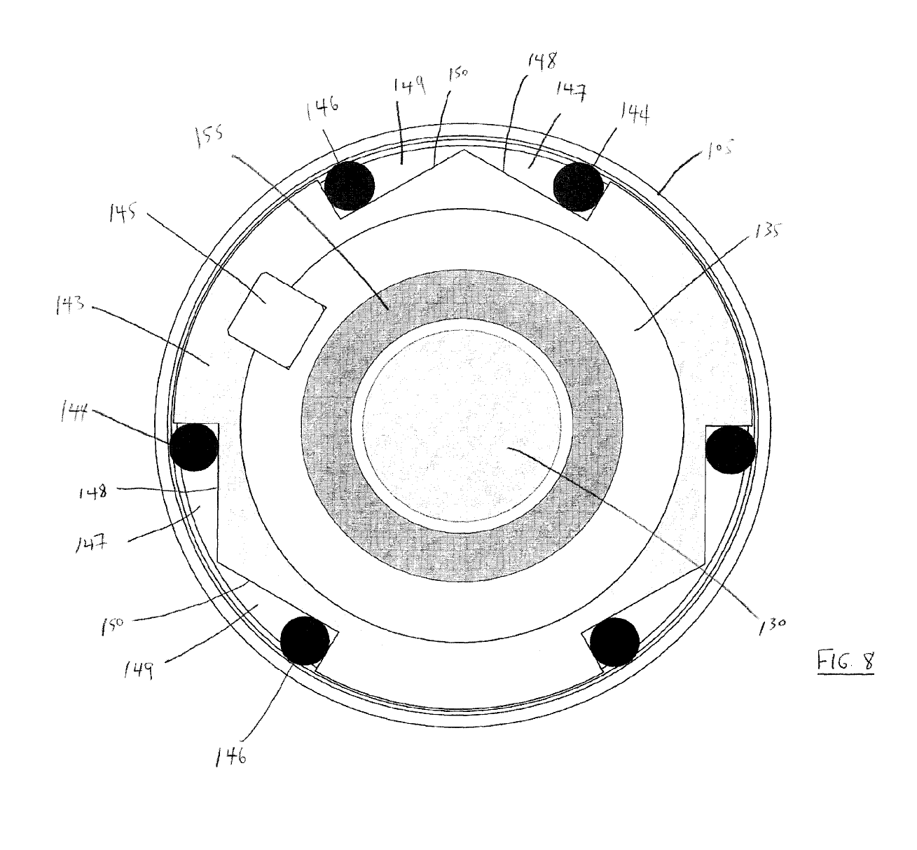

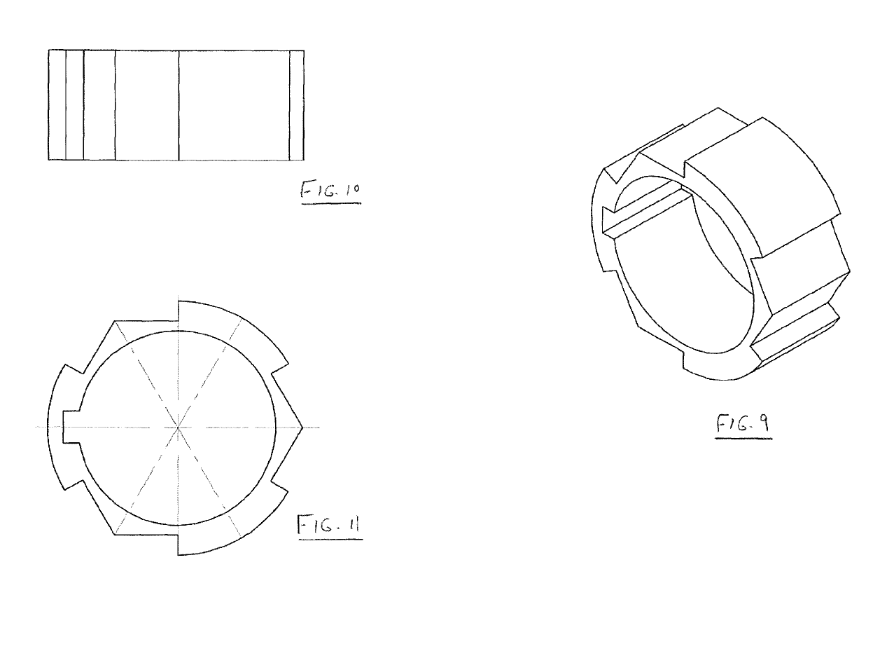

With reference to FIGS. 5-8, there is shown a portion of cleaning apparatus 100 without the exterior portion of rodless cylinder 105, motor 110, shroud 120 and slidable element 125. These elements have been excluded from FIGS. 5-8 for clarity only.

Thus, driving element 135 comprises a friction modifying element 140 on opposed ends thereof. Interposed between friction modifying elements 140 on driving element 135 are a plurality of magnets 160 which interact with magnets on slidable member 125 (not shown in FIGS. 1-4), but the details of which can be found in Pearcey and Traubenberg et al. referred to above.

With reference to FIG. 8, the interaction between friction modifying element 140 and the interior surface of rodless cylinder 105 may be understood. Thus, it can be seen that friction modifying element 140 comprises an annular element 143 which is secured with respect to driving element 135 by a key element 145. Annular element 143 comprises a pair of opposed receptacles 147,149. Receptacle 147 is configured to have a planer face 148 whereas receptacle 149 is configured to have a planar face 150. Disposed within receptacle 147 is a roller element 144 whereas disposed within receptacle 149 is a roller element 146. As can be seen, there are three pairs of receptacles 147,149 and roller elements 144,146 disposed in annular element 143. In the illustrated embodiment, annular element 143 may be regarded as a so-called “star wheel”.

With further reference to FIG. 8, it can be seen that a coupling nut 155 is secured to screw drive 130 and driving element 135.

FIGS. 10-11 illustrate various views of annular element 143.

With further reference to FIG. 8, cleaning apparatus 100 operates in the following fashion. When screw drive 130 is rotated in a clockwise direction, any rotational force on annular element 143 is conveyed to roller element 146 which is driven or wedged in the space between planer surface 140 and the interior surface of rodless cylinder 105. This effectively prevents rotational movement of annular element 143 and promotes longitudinal movement thereof which translates driving member 135 along the interior of rodless cylinder 105.

Conversely, when driving element 130 is rotated in a counter clockwise direction, any rotational force conveyed to annular element 143 is then conveyed to roller element 144 which becomes trapped or wedged in the space between planer surface 148 and the interior surface of rodless cylinder 105. Again, this serves to prevent rotation of annular element 143 and promotes longitudinal movement of driving member 135 along the interior surface of rodless cylinder 105.

Thus, it will be understood by those of ordinary skill in the art that the provision of receptacles 147,148 having cross-sectional shapes that are mirror images of each other about an axis which bisects them allows for prevention of rotational movement of annular element 143 bi-directionally. It is of course possible to modify the precise cross-section shapes of receptacles 147,148 while maintaining this function.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A cleaning apparatus for a radiation source assembly in a fluid treatment system, the cleaning system comprising:
a cleaning carriage comprising at least one cleaning element for contact with at least a portion of the exterior of the radiation source assembly;
a rodless cylinder comprising an elongate housing having a longitudinal axis;
a slidable element disposed on an exterior surface of the elongate housing, the slidable element being: (i) coupled to the cleaning carriage, and (ii) magnetically coupled to a driving element disposed within the elongate housing, the driving element comprising a friction modifying element in contact with an interior surface of the elongate housing to define a first frictional resistance in a rotational direction about the longitudinal axis and a second frictional resistance in an axial direction along the longitudinal axis, the friction modifying element configured such that the first frictional resistance is greater than the second friction resistance; and
an elongate motive element coupled to the driving element.

2. The cleaning apparatus defined in claim 1, wherein the friction modifying element is configured to substantially prevent rotation of the driving element about the longitudinal axis.

3. The cleaning apparatus defined in claim 1, wherein the driving element is coaxially oriented with respect to the longitudinal axis of the elongate housing.

4. The cleaning apparatus defined in claim 1, wherein the friction modifying element comprises an annular element having a receptacle portion configured to receive a roller element, the roller element configured to be in contact with the interior surface of the elongate housing.

5. The cleaning apparatus defined in claim 4, wherein the receptacle portion has cross-sectional shape configured to urge the roller element against the interior of the elongate housing open rotation of the annular element about the longitudinal axis.

6. The cleaning apparatus defined in 4, wherein the annular element comprises a first receptacle configured to receive a first roller element and a second receptacle configured to receive second roller element.

7. The cleaning apparatus defined in claim 4, wherein the first receptacle portion has first cross-sectional shape configured to urge the roller element against the interior of the elongate housing open rotation of the annular element about the longitudinal axis in a first direction.

8. The cleaning apparatus defined in claim 7, wherein the second receptacle portion has second cross-sectional shape configured to urge the roller element against the interior of the elongate housing open rotation of the annular element about the longitudinal axis in a second direction opposed to the first direction.

9. The cleaning apparatus defined in claim 8, wherein the first cross-sectional shape and the second cross-sectional shape are different.

10. The cleaning apparatus defined in claim 8, wherein the first cross-sectional shape and the second cross-sectional shape are substantially the same.

11. The cleaning apparatus defined in claim 10, wherein the first cross-sectional shape and the second cross-sectional shape are substantially mirror images of one another about an axis perpendicular to the longitudinal axis of the elongate housing.

12. The cleaning apparatus defined in claim 6, wherein the annular member comprises two or more pairs of the first receptacle and the second receptacle.

13. The cleaning apparatus defined in claim 6, wherein the annular member comprises three pairs of the first receptacle and the second receptacle.

14. The cleaning apparatus defined in claim 1, further comprising a key element configured to secure the friction modifying element with respect to the driving element.

15. The cleaning apparatus defined in 4, further comprising a key element configured to secure the annular element with respect to the driving element.

16. The cleaning apparatus defined in claim 1, wherein the friction modifying element is coupled to an end portion of the driving element.

17. The cleaning apparatus defined in 1, wherein the driving element comprises a pair of friction modifying elements.

18. The cleaning apparatus defined in claim 17, wherein the pair of friction modifying elements are coupled to opposed end portions of the driving element.

19-39. (canceled)

40. A radiation source module for use in a fluid treatment system, the module comprising:
a frame having a first support member;
at least one radiation source assembly extending from the first support member, the at least one radiation source assembly comprising a radiation source; and
the cleaning apparatus defined in claim 1, the cleaning element of the cleaning carriage being in contact with at least a portion of an exterior of the at least one radiation source assembly.

41-50. (canceled)

51. A fluid treatment system comprising a fluid treatment zone for receiving a flow of fluid and at least one radiation source module defined in claim 40, wherein the at least one radiation source module is configured such that the one radiation source assembly is disposed in the fluid treatment zone.

52-57. (canceled)
